(19) United States
(12) Patent Application Publication
(10) Pub. No.: US 2026/0323273 A1
(43) Pub. Date: Oct. 15, 2026

(54) METHOD OF ML MODEL CONFIGURATION AND SIGNALING

(71) Applicant: AUMOVIO GERMANY GmbH, Frankfurt am Main (DE)

(72) Inventors: Hojin Kim, Regensburg, Bavaria (DE); Rikin SHAH, Langen, Hessen (DE); Andreas ANDRAE, Friedberg (DE)

(73) Assignee: AUMOVIO GERMANY GmbH, Frankfurt am Main (DE)

(21) Appl. No.: 19/482,942

(22) PCT Filed: May 7, 2024
(86) PCT No.: PCT/EP2024/062498

§ 371 Date: Nov. 10, 2025

(30) Foreign Application Priority Data
May 11, 2023 (DE) 10 2023 204 381.5

(51) Int. Cl. H04W 8/18; H04L 41/16; H04W 4/06; H04W 24/10

(52) U.S. Cl. CPC H04W 8/186; H04L 41/16; H04W 4/06; H04W 24/10

(57) ABSTRACT

The present disclosure describes methods of data-driven AI/ML model signaling for quasi-based machine learning model operation in wireless mobile communication system including base station (e.g., gNB) and mobile station (e.g., UE). The quasi-relationship is measured for different types of model operation between network and UE so that this measurement can be applied to varying applications with signaling overhead reduction.

### CROSS REFERENCE TO RELATED APPLICATIONS

This application is the U.S. National Phase Application of PCT International Application No. PCT/EP2024/062498, filed May 7, 2024, which claims priority to German Patent Application No. 10 2023 204 381.5, filed May 11, 2023, the contents of such applications being incorporated by reference herein.

### FIELD OF THE INVENTION

The present disclosure relates to AI/ML based model signaling, where techniques for pre-configuring and signaling the specific information about quasi-relation of machine learning model operation with different types are presented.

### BACKGROUND OF THE INVENTION

In 3GPP (3rd Generation Partnership Project), one of the selected study items as the approved Release 18 package is AI/ML (artificial intelligence/machine learning) as described in the related document (RP-213599) addressed in 3GPP TSG RAN (Technical Specification Group Radio Access Network) meeting #94e. The official title of AI/ML study item is “Study on AI/ML for NR Air Interface”, incorporated herein by reference, and currently RAN WG1 and WG2 are actively working on specification. The goal of this study item is to identify a common AI/ML framework and areas of obtaining gains using AI/ML based techniques with use cases.

According to 3GPP, the main objective of this study item is to study AI/ML framework for air-interface with target use cases by considering performance, complexity, and potential specification impact. In particular, AI/ML model, terminology and description to identify common and specific characteristics for framework will be one of key work scope. Regarding AI/ML framework, various aspects are under consideration for investigation and one of key items is about lifecycle management of AI/ML model where multiple stages are included as mandatory for model training, model deployment, model inference, model monitoring, model updating etc.

Earlier, in 3GPP TR 37.817 for Release 17, titled as Study on enhancement for Data Collection for NR and EN-DC, incorporated herein by reference, UE mobility was also considered as one of AI/ML use cases and one of scenarios for model training/inference is that both functions are located within RAN node. Followingly, in Release 18 the new work item of “Artificial Intelligence (AI)/Machine Learning (ML) for NG-RAN”, incorporated herein by reference, was initiated to specify data collection enhancements and signaling support within existing NG-RAN interfaces and architecture.

For the above active standardization works, currently there is no specification defined for signaling methods or network (e.g., gNB)/mobile station (e.g., UE) behaviors about supporting AI/ML model operation when model transfer is required with specific collaboration type(s), and model transfer between network and UE could happen quite frequently for various use cases/scenarios with ML operation. As a result, latency and/or signaling overhead would occur.

US2022374785A1, incorporated herein by reference, describes a machine learning system that performs transfer learning to output a trained model by performing training using a parameter of a pre-trained model by using a given dataset and a given pre-trained model.

WO2022232092A1, incorporated herein by reference, shows the paging pattern of different UEs for communication between network access node and UE.

WO2022216209A1 studies wireless device having a quasi-co location (QCL) relation parameter. US2019296868A1 and

US2023079502A1, incorporated herein by reference, shows method and device for representing a QCL parameter configuration, acquiring QCL characteristic parameter set including part or all of characteristic parameters.

The described problem is solved by the different aspects and the embodiments of this application. The first embodiment of the first aspect is a method of ML model configuration and signaling by forming Quasi-Co-ML (QCML) relationship for indication of models/datasets having the same or similar ML properties, comprising, configuring QCML relationship based on the pre-configured finite set of ML properties, Setting QCML table that contains a list of types, properties, and applicable model operations, determining QCML relationship with multiple models/datasets (e.g., based on either measurement report from UE and/or QCML repository), selecting a model having QCML relationship with other models (e.g., based on minimum model complexity/model size together with channel quality measure by comparing candidate models with QCML relationship)

In some embodiments of the method according to the first aspect, the method is characterized by, that the configured QCML relationship is updated dynamically through L1/L2 signaling. when the current QCML relationship is not valid anymore).

In some embodiments of the method according to the first aspect, the method is characterized by, that the configured QCML relationship is updated dynamically through L1/L2 signaling, when the current QCML relationship is not valid anymore.

In some embodiments of the method according to the first aspect, the method is characterized by, that QCML relationship can also have two or more QCML types simultaneously depending on ML properties and ML operations.

In some embodiments of the method according to the first aspect, the method is characterized by, that multiple pairs of ML models between network side and UE side can be identified as pairs of models having QCML relationship.

In some embodiments of the method according to the first aspect, the method is characterized by, that QCML table comprises type (a finite set of type indexes), ML properties (different number of subsets of ML model related components, characteristics, KPIs, etc.), and ML operations (applicable ML model related operations for lifecycle phases).

In some embodiments of the method according to the first aspect, the method is characterized by, that QCML relationship is measured by UE side and/or network side, comprising, reporting measurement of QCML relationship network side, determining QCML type to apply when two or more ML related operations need to be executed, scheduling measurement report dynamically or semi-statically, transmitting a QCML relationship indication message by indicating QCML relationship, reporting the similarity level of candidate target ML properties or decision indication about QCML relationship.

In some embodiments of the method according to the first aspect, the method is characterized by, that the UE with Multi-USIM (MUSIM) having separate ML model operations with network uses QCML relation indication across different USIM links with model operations applying QCML relationship measured with QCML type determination to MUSIM links.

In some embodiments of the method according to the first aspect, the method is characterized by, that the UE with MUSIM having separate ML model operations with network, whereby one-sided or two-sided model defined in 3GPP AI/ML is used

In some embodiments of the method according to the first aspect, the method is characterized by, that the multiple UEs are grouped together based on QCML relationship, comprising, UEs in the same group performing the common QCML type based operation, groupcast or multicast signaling to transmit QCML related messages to specific UE group(s)

In some embodiments of the method according to the first aspect, the method is characterized by, that the groupcast or multicast signaling to transmit QCML related messages to specific UE group(s) is done by RRC signaling to deliver QCML configuration information and L1/L2 signaling to support QCML indication message/measurement report and activation/deactivation of QCML operation.

In some embodiments of the method according to the first aspect, the method is characterized by, that the target ML properties with different QCML types and applications for multiple datasets and/or models can be split into groups where each group has the same QCML relationship.

In some embodiments of the method according to the first aspect, the method is characterized by, that the categories of QCML properties are extended to multiple elements such as device specific elements, site specific elements, application specific elements, ML specific elements for different combinations of the configurable

QCML relationship formation according to ML lifecycle management, device, site, and application.

According to a second aspect, the present disclosure relates to an apparatus for ML model configuration and signaling by forming Quasi-Co-ML (QCML) relationship for indication of models/datasets having the same or similar ML properties the apparatus comprising a wireless transceiver, a processor coupled with a memory in which computer program instructions are stored, said instructions being configured to implement steps according to the first aspect.

According to a third aspect, the present disclosure relates to a user Equipment comprising an apparatus according to any one of the embodiments of the second aspect

According to a fourth aspect, the present disclosure relates to a base-station comprising an apparatus according to any one of the embodiments of the second aspect.

According to a fourth aspect, the present disclosure relates to a wireless communication system, wherein the gNB comprises a processor coupled with a memory in which computer program instructions are stored, said instructions being configured to implement steps according to first aspect, wherein the user equipment (UE) comprises a processor coupled with a memory in which computer program instructions are stored, said instructions being configured to implement steps of the first aspect.

### BRIEF DESCRIPTION OF THE DRAWINGS

FIG. 1 is an exemplary block diagram of QCML relationship mapping between network and UE.

FIG. 2 is an exemplary table of QCML.

FIG. 3 is a signaling flow of QCML type determination at network.

FIG. 4 is a signaling flow of QCML type determination at UE.

FIG. 5 is an exemplary block diagram of QCML based on the pre-configured relation.

FIG. 6 is an exemplary block diagram of QCML based on measurement at UE.

FIG. 7 is an exemplary block diagram of QCML based on serving multiple UEs.

FIG. 8 is a signaling flow of QCML for MUSIM.

FIG. 9 is an exemplary block diagram of QCML based UE grouping.

FIG. 10 is an exemplary block diagram of QCML grouping.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other aspects, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc readonly memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements

The detailed description set forth below, with reference to the figures, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. For instance, although 3GPP terminology, from e.g., 5G NR, may be used in this disclosure to exemplify embodiments herein, this should not be seen as limiting the scope of the present disclosure.

The disclosure is related to wireless communication system, which may be for example a 5G NR wireless communication system. More specifically, it represents a RAN of the wireless communication system, which is used exchange data with UEs via radio signals. For example, the RAN may send data to the UEs (downlink, DL), for instance data received from a core network (CN). The RAN may also receive data from the UEs (uplink, UL), which data may be forwarded to the CN.

In the examples illustrated, the RAN comprises one base station, BS. Of course, the RAN may comprise more than one BS to increase the coverage of the wireless communication system. Each of these BSs may be referred to as NB, eNodeB (or eNB), gNodeB (or gNB, in the case of a 5G NR wireless communication system), an access point or the like, depending on the wireless communication standard(s) implemented.

The UEs are located in a coverage of the BS. The coverage of the BS corresponds for example to the area in which UEs can decode a PDCCH transmitted by the BS.

An example of a wireless device suitable for implementing any method, discussed in the present disclosure, performed at a UE corresponds to an apparatus that provides wireless connectivity with the RAN of the wireless communication system, and that can be used to exchange data with said RAN. Such a wireless device may be included in a UE. The UE may for instance be a cellular phone, a wireless modem, a wireless communication device, a handheld device, a laptop computer, or the like.

The UE may also be an Internet of Things (IoT) equipment, like a wireless camera, a smart sensor, a smart meter, smart glasses, a vehicle (manned or unmanned), a global positioning system device, etc., or any other equipment that may run applications that need to exchange data with remote recipients, via the wireless device.

The wireless device comprises one or more processors and one or more memories. The one or more processors may include for instance a central processing unit (CPU), a digital signal processor (DSP), a field-programmable gate array (FPGA), an application specific integrated circuit (ASIC), etc. The one or more memories may include any type of computer readable volatile and non-volatile memories (magnetic hard disk, solid-state disk, optical disk, electronic memory, etc.). The one or more memories may store a computer program product, in the form of a set of program-code instructions to be executed by the one or more processors to implement all or part of the steps of a method for exchanging data, performed at a UE's side, according to any one of the embodiments disclosed herein.

The wireless device can comprise also a main radio, MR, unit. The MR unit corresponds to a main wireless communication unit of the wireless device, used for exchanging data with BSs of the RAN using radio signals. The MR unit may implement one or more wireless communication protocols, and may for instance be a 3G, 4G, 5G, NR, WiFi, WiMax, etc. transceiver or the like. In preferred embodiments, the MR unit corresponds to a 5G NR wireless communication unit.

The following explanation will provide the detailed description of the mechanism about data-driven AI/ML model signaling for quasi-based ML model operation in wireless mobile communication system including base station (e.g., gNB) and mobile station (e.g., UE) AI/ML lifecycle can be split into several stages such as data collection/pre-processing, model training, model testing/validation, model deployment/update, model monitoring, model switching/selection etc., where each stage is equally important to achieve target performance with any specific model(s). In applying AI/ML model for any use case or application, one of the challenging issues is to manage the lifecycle of AI/ML model. It is mainly because the data/model drift occurs during model deployment/inference and it results in performance degradation of AI/ML model. Fundamentally, the dataset statistical changes occur after model is deployed and model inference capability is also impacted with unseen data as input. In a similar aspect, the statistical property of dataset and the relationship between input and output for the trained model can be changed with drift occurrence. Then model adaptation is required to support operations such as model switching, re-training, fallback, etc. When AI/ML model enabled wireless communication network is deployed, it is then important to consider how to handle adaptation of AI/ML model under operations such as model training, inference, monitoring, updating, etc.

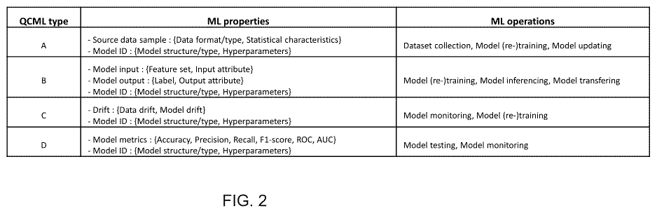

Based on specific network-UE collaboration scenarios for ML operation, model transfer is requested from one side to the other side when there are two or more models on network side and/or UE side for model operation. In this scenario, frequent model transfers between network and UE might cause high signaling overhead depending on different use cases with varying models. Target models to transfer can be identified to measure “Quasi-Co-ML (QCML)” relationship that indicates models having the same or similar ML properties. QCML relationship is configured, comprising a list of types, properties, and applicable model operations. And a finite set of ML properties are then pre-configured to generate multiple parameter sets with different characteristics. For signaling aspect, QCML configuration information can be delivered through RRC message. The criteria of selecting a model having QCML relationship with other models for model transfer can be based on minimum model complexity/model size together with channel quality measure by comparing candidate models with QCML relationship. QCML relationship can be determined by network side or UE side (depending on different use cases/applications) based on either measurement report from UE and/or QCML model repository. Also the configured QCML relationship can be or updated dynamically through L1/L2 signaling when the current QCML relationship is not valid anymore. QCML relationship can also have two or more QCML types simultaneously depending on ML properties and ML operations. For example (based on the exemplary QCML table in FIG. 2), when QCML relationship has QCML type A, it indicates that two or more separate set of data samples have the same or similar characteristics/data format/type so that only one of them can be enabled to represent all those datasets without having to use all datasets separately. When QCML relationship has QCML type B, it indicates that two or more separate ML models have the same or similar ML properties for model input/output and model ID information so that only one of them can be enabled to represent all those models without having to activate all models separately.

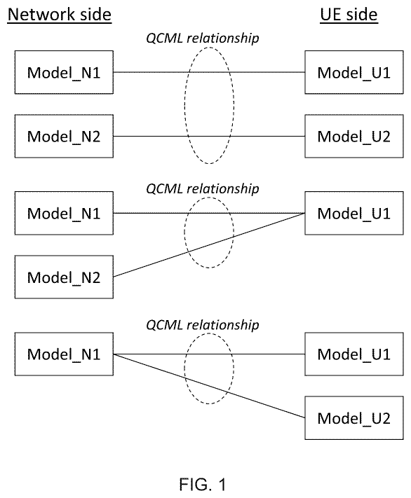

FIG. 1 shows an exemplary block diagram of QCML relationship mapping between network and UE. In this figure, Model_N1 and Model_N2 are located in network side and Model_U1 and Model_U2 are located in UE side as two-sided model examples. However, there can be other scenarios such as one-sided model or UE-sided model when model is only applied to UE. There can be multiple pairs of ML models between network side and UE side, where some pairs of models have QCML relationship. If any QCML relationship for the paired models is determined on either network side or UE side, the indication message of QCML type/relationship can be sent to the other side so that only one of paired models belonging to QCML relationship can be operated. For one-sided model scenarios, the same method can be applied where only one of models among multiple models having QCML relationship can be enabled for operation.

FIG. 2 shows an exemplary table of QCML. QCML table comprises type (a finite set of type indexes), ML properties (different number of subsets of ML model related components, characteristics, KPIs, etc.), and ML operations (applicable ML model related operations for lifecycle phases). A finite set of ML properties are pre-configured to generate multiple subsets of different combinations for each types where the number of types can be adaptively configured in advance based on network configurations and/or applications. Each subsets of different combinations of finite set of ML properties are then mapped to different type index for indication to be used for target model operations based on the associated subset of ML properties.

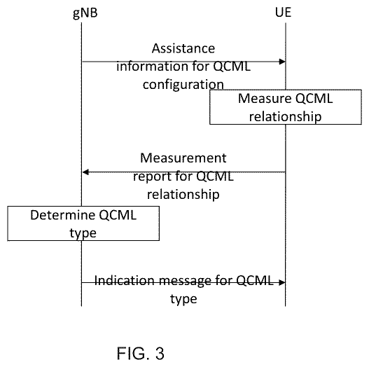

FIG. 3 shows a signaling flow of QCML type determination at network. In this signaling flow, QCML relationship is measured by UE side and measurement is reported to network side. Network side determines then QCML type to apply when two or more ML related operations need to be executed. Based on QCML type for activation, multiple ML operation can be reduced. QCML update and/or measurement report can be dynamically or semi-statically scheduled. In other words, network side can determine two or more models or ML properties that have the same QCML relationship and may transmit a QCML relationship indication message to UE(s) by indicating QCML relationship. Also UE can report the similarity level of candidate target ML properties or decision indication about QCML relationship.

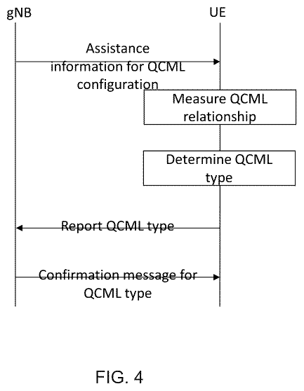

FIG. 4 shows a signaling flow of QCML type determination at UE. In this signaling flow, QCML relationship is measured by UE side and QCML type is also determined by UE. QCML type is then reported to network side so that network side sends confirmation message to UE about QCML type reported.

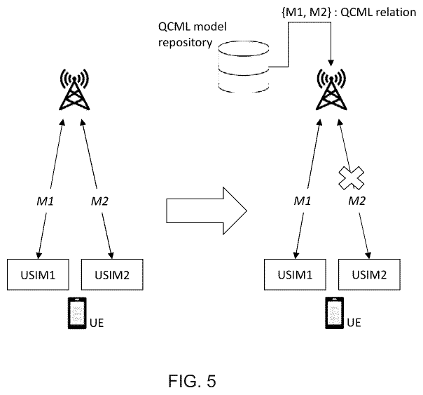

FIG. 5 shows an exemplary block diagram of QCML based on the pre-configured relation. When UE has two USIMs (universal subscriber identity module) having separate ML model operations with network (e.g., one-sided or two-sided model defined in 3GPP AI/ML). Without QCML relation, M1 model and M2 model are independently activated for radio links with USIM1 and USIM2, respectively, where M1 is one-/two-sided model (e.g., model ID) between network and UE (USIM1) and M2 is one-/two-sided model (e.g., model ID) between network and UE (USIM2). With QCML relation based on information from repository (when there are a list of pre-configured QCML model data in advance), QCML relation is indicated to UE and M1 operation for USIM1 can be applied to USIM2 by conveying its output. And M2 is not enabled then.

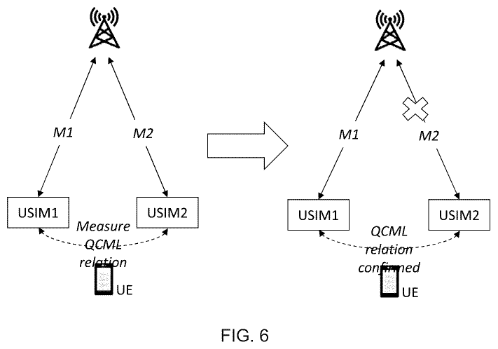

FIG. 6 shows an exemplary block diagram of QCML based on measurement at UE. In this example, QCML relation for M1 and M2 is measured at UE without depending on the pre-configured QCML data repository. Based on QCML measurement request from network, UE performs measurement through USIM1 and USIM2. After QCML relation is confirmed, M1 for USIM1 is only operated and applied to USIM2 by conveying its output.

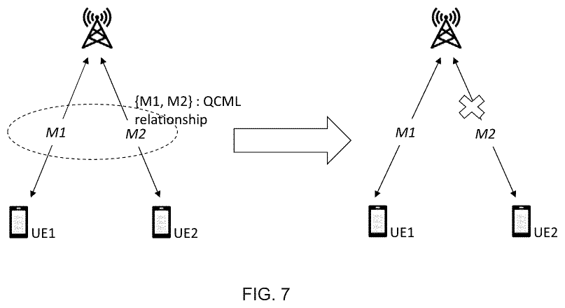

FIG. 7 shows an exemplary block diagram of QCML based on serving multiple UEs. When there are two UEs having separate ML model operations with network (e.g., one-sided or two-sided model defined in 3GPP AI/ML), without using QCML relation, M1 model and M2 model are independently activated for radio links with UE1 and UE2, respectively. With QCML relation, M1 operation with UE1 is applied to UE2 by not enabling M2.

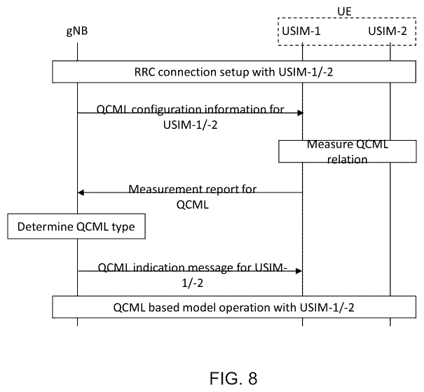

FIG. 8 shows a signaling flow of QCML for multi-USIM (MUSIM). When UE has multiple USIMs that communicate with network for separate ML based model operation, QCML relation can be measured and QCML type can be determined based on measurement. Based on QCML indication signaling, QCML based model operation can be activated for any specific QCML type. This can be deployed for different configurations of MUSIM.

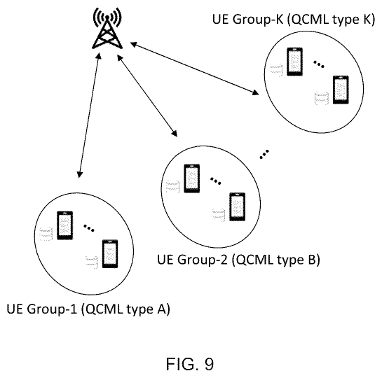

FIG. 9 shows an exemplary block diagram of QCML based UE grouping. Multiple UEs can be also grouped together based on QCML so that UEs in the same group performs the common QCML type based operation. QCML based UE grouping contributes to signaling overhead reduction as well as latency reduction depending on different types of QCML relations. Groupcast or multicast signaling can be used to transmit QCML related messages to specific UE group(s). For example, RRC signaling can be used to deliver QCML configuration information while L1/L2 signaling can be used to support QCML indication message/measurement report and activation/deactivation of QCML operation.

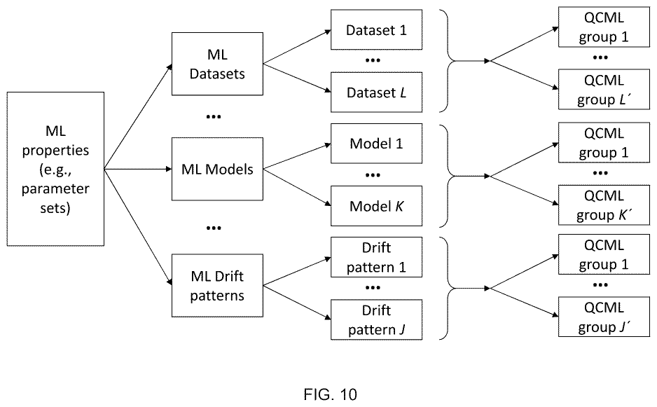

FIG. 10 shows an exemplary block diagram of QCML grouping. For target ML properties with different QCML types and applications, multiple datasets and/or models can be split into groups where each group has the same QCML relationship. This can be applied to both network side and/or UE side where different datasets and/or models are available as those can be grouped into separate QCML relationship.

In the proposed method, the categories of QCML properties can be also extended to multiple elements such as device specific elements, site specific elements, application specific elements, ML specific elements for different combinations of the configurable QCML relationship formation according to ML LCM (lifecycle management), device, site, and application.

Abbreviations:

| | |
|---|---|
| BWP | Bandwidth part |
| CBG | Code block group |
| CLI | Cross Link Interference |
| CP | Cyclic prefix |
| CQI | Channel quality indicator |
| CPU | CSI processing unit |
| CRB | Common resource block |
| CRC | Cyclic redundancy check |
| CRI | CSI-RS Resource Indicator |
| CSI | Channel state information |
| CSI-RS | Channel state information reference signal |
| CSI-RSRP | CSI reference signal received power |
| CSI-RSRQ | CSI reference signal received quality |
| CSI-SINR | CSI signal-to-noise and interference ratio |
| CW | Codeword |
| DCI | Downlink control information |
| DL | Downlink |
| DM-RS | Demodulation reference signals |
| DRX | Discontinuous Reception |
| EPRE | Energy per resource element |
| IAB-MT | Integrated Access and Backhaul - Mobile Terminal |
| L1-RSRP | Layer 1 reference signal received power |
| LI | Layer Indicator |
| MCS | Modulation and coding scheme |
| PDCCH | Physical downlink control channel |
| PDSCH | Physical downlink shared channel |
| PSS | Primary Synchronisation signal |
| PUCCH | Physical uplink control channel |
| QCL | Quasi co-location |
| PMI | Precoding Matrix Indicator |
| PRB | Physical resource block |
| PRG | Precoding resource block group |
| PRS | Positioning reference signal |
| PT-RS | Phase-tracking reference signal |
| RB | Resource block |
| RBG | Resource block group |
| RI | Rank Indicator |
| RIV | Resource indicator value |
| RS | Reference signal |
| SCI | Sidelink control information |
| SLIV | Start and length indicator value |
| SR | Scheduling Request |
| SRS | Sounding reference signal |
| SS | Synchronisation signal |
| SSS | Secondary Synchronisation signal |
| SS-RSRP | SS reference signal received power |
| SS-RSRQ | SS reference signal received quality |
| SS-SINR | SS signal-to-noise and interference ratio |
| TB | Transport Block |
| TCI | Transmission Configuration Indicator |
| TDM | Time division multiplexing |
| UE | User equipment |
| UL | Uplink |

1. A method of ML model configuration and signaling by forming Quasi-Co-ML (QCML) relationship for indication of models/datasets having the same or similar ML properties, comprising:
Configuring QCML relationship based on the pre-configured finite set of ML properties;
Setting QCML table that contains a list of types, properties, and applicable model operations;
Determining QCML relationship with multiple models/datasets (e.g., based on either measurement report from UE and/or QCML repository); and
Selecting a model having QCML relationship with other models (e.g., based on minimum model complexity/model size together with channel quality measure by comparing candidate models with QCML relationship).

2. The method according to claim 1, wherein the configured QCML relationship is updated dynamically through L1/L2 signaling. when the current QCML relationship is not valid anymore).

3. The method according to claim 1, wherein the configured QCML relationship is updated dynamically through L1/L2 signaling, when the current QCML relationship is not valid anymore.

4. The method according to claim 1, wherein QCML relationship can also have two or more QCML types simultaneously depending on ML properties and ML operations.

5. The method according to claim 1, wherein multiple pairs of ML models between network side and UE side can be identified as pairs of models having QCML relationship.

6. The method according to claim 1, wherein QCML table comprises type (a finite set of type indexes), ML properties (different number of subsets of ML model related components, characteristics, KPIs, etc.), and ML operations (applicable ML model related operations for lifecycle phases).

7. The method according to claim 1, wherein QCML relationship is measured by UE side and/or network side, comprising:
Reporting measurement of QCML relationship network side;
Determining QCML type to apply when two or more ML related operations need to be executed;
Scheduling measurement report dynamically or semi-statically;
Transmitting a QCML relationship indication message by indicating QCML relationship; and
Reporting the similarity level of candidate target ML properties or decision indication about QCML relationship.

8. The method according to claim 1, wherein UE with Multi-USIM (MUSIM) having separate ML model operations with network uses QCML relation indication across different USIM links with model operations applying QCML relationship measured with QCML type determination to MUSIM links.

9. The method according to claim 1, wherein UE with MUSIM having separate ML model operations with network, whereby one-sided or two-sided model defined in 3GPP AI/ML is used.

10. The method according to claim 1, wherein multiple UEs are grouped together based on QCML relationship, comprising:
UEs in the same group performing the common QCML type based operation; and
Groupcast or multicast signaling to transmit QCML related messages to specific UE group(s) (e.g., RRC signaling to deliver QCML configuration information and L1/L2 signaling to support QCML indication message/measurement report and activation/deactivation of QCML operation)

11. The method according to claim 1, wherein the groupcast or multicast signaling to transmit QCML related messages to specific UE group(s) is done by RRC signaling to deliver QCML configuration information and L1/L2 signaling to support QCML indication message/measurement report and activation/deactivation of QCML operation.

12. The method according to claim 1, wherein target ML properties with different QCML types and applications for multiple datasets and/or models can be split into groups where each group has the same QCML relationship.

13. The method according to claim 1, wherein the categories of QCML properties are extended to multiple elements such as device specific elements, site specific elements, application specific elements, ML specific elements for different combinations of the configurable QCML relationship formation according to ML lifecycle management, device, site, and application.

14. An apparatus for of ML model configuration and signaling by forming Quasi-Co-ML (QCML) relationship for indication of models/datasets having the same or similar ML properties the apparatus comprising a wireless transceiver, a processor coupled with a memory in which computer program instructions are stored, said instructions being configured to implement the method of claim 1

15. A User Equipment comprising an apparatus according to claim 13.

16. A base station comprising an apparatus according to claim 13.

17. A wireless communication system, wherein the gNB comprises a processor coupled with a memory in which computer program instructions are stored,
wherein the user equipment (UE) comprises a processor coupled with a memory in which computer program instructions are stored,
said stored computer instructions in each of said memories being configured to implement the method of claim 1.
